(19) United States
(12) Patent Application Publication
(10) Pub. No.: US 2025/0317804 A1
(43) Pub. Date: Oct. 9, 2025

(54) STORAGE DEVICE AND OPERATING METHOD THEREOF

(71) Applicant: EUCAST CO., LTD., Gyeonggi-do (KR)

(72) Inventors: Jaehyeong Kim, Seoul (KR); Shin Ha Kang, Gyeonggi-do (KR); Jee Eun Lee, Gyeonggi-do (KR)

(21) Appl. No.: 18/789,358

(22) Filed: Jul. 30, 2024

(30) Foreign Application Priority Data
Apr. 9, 2024 (KR) 10-2024-0047960

(51) Int. Cl. H04W 28/20; H04W 52/30; H04W 72/044; H04W 72/0453

(52) U.S. Cl. CPC H04W 28/20; H04W 52/30; H04W 72/0453; H04W 72/0473

(57) ABSTRACT

The prevent disclosure relates to a method for operating a mobile base station configured to provide a wireless communication service using a CBRS frequency bandwidth. Disclosed is a method for operating a mobile base station), including: registering the base station in a spectrum access system (SAS) server; requesting information on an available CBRS channel based on the position information of the base station to the SAS server; receiving the information on an available CBRS from the SAS server; determining a CBRS channel to be used and a maximum transmission power based on the information on an available CBRS channel; requesting an approval on the CBRS channel to be used and the maximum transmission power to the SAS server; receiving an approval message from the SAS server; and providing a wireless communication service based on the determined CBRS channel to be used and the maximum transmission power.

### CROSS-REFERENCE TO RELATED APPLICATIONS

The present application claims the benefit 35 U.S.C. 119 (a) of Korea Patent Application No. 10-2024-0047960, filed Apr. 9, 2024, the entire contents of which is incorporated herein for all purposes by this reference.

### FIELD

The prevent disclosure relates to a method for operating a mobile base station configured to provide a wireless communication service using a CBRS frequency bandwidth.

### BACKGROUND

The Citizen's Broadband Radio Service (CBRS) uses a wireless frequency of 150 MHz width of 3.5 GHz bandwidth which is approved for the shared civilian wireless data communication service, and to which a license is not issued.

A lot of users may use the CBRS bandwidth at a low cost similarly to the WIFI service because no exclusive license at a high cost is issued to the CBRS bandwidth. However, the CBRS bandwidth is allocated to the US Navy and fixed satellites, and the use of the CBRS bandwidth may be allowed only if satisfying special conditions.

Three user layers to which the use of the CBRS bandwidth is allowed may be defined. The first user layer is the current users who are allocated to use the current corresponding frequency region such as the US Navy and the fixed satellites. The second user layer is the users of the priority access license (PAL), and mobile carriers, who paid the expenses to obtain the license of some of the frequencies, may belong to the second layer. The third user layer is small-scale operators who did not obtain a license to make use of the CBRS bandwidth in their own private networks.

The first user layer has the highest priority, the PAL users have the second-next priority, and the GAA users have the lowest priority. Therefore, the GAA users may use the CBRS bandwidth only when they do not interfere with the current users and the PAL users, and the PAL users may use the CBRS bandwidth when they do not interfere with the current users. In order to manage the interference among users, the Spectrum Access System (SAS) may be needed.

Mobile base stations such as the Network-In-A-Box (NIB), or the Cell-On-Wheel (COW) have both the base station equipment, and the core network equipment, therefore, may configure own mobile communication networks (4G/5G). Therefore, the mobile base stations may be provided in regions where there is no existing mobile communication network, or where the existing mobile communication networks cannot function due to disasters etc. so that the mobile communication service can be provided to the subscribers within a certain radius.

According to an embodiment, the mobile base station may be mounted on a vehicle to be applied on land, may be mounted on a vessel on the sea to provide the communication service within the vessel, and to other nearby vessels within the coverage region of the mobile base station.

At the moment, the US regulation authorities define only the SAS rules and regulations with regard to the fixed type base stations, and do not define the SAS rules and regulations with regard to the mobile base stations.

### SUMMARY

The embodiments of the present disclosure provide a method for operating a mobile base station which allows a mobile communication service using the CBRS frequency bandwidth.

One embodiment is a mobile base station configured to provide a wireless communication service using a citizen's broadband radio service (CBRS) frequency, including: a core (enhanced packet core or 5G core); and a base station, each of which being provided in one box, the base station may be configured to be operated as a citizen's broadband radio service device (CBSD), the core may have CBSD information of the base station, the base station may be configured to obtain position information and transmit the position information to the core, and the core may be configured to register the base station in a spectrum access system (SAS) server based on the CBSD information of the base station; request information on an available CBRS channel based on the position information of the base station to the SAS server; receive the information on an available CBRS channel based on the position information from the SAS server; determine a CBRS channel to be used and a maximum transmission power based on the information on an available CBRS channel; request an approval on the CBRS channel to be used and the maximum transmission power to the SAS server; receive an approval message from the SAS server; transmit the determined CBRS channel to be used and the maximum transmission power to the base station; and provide a wireless communication service based on the determined CBRS channel to be used and the maximum transmission power.

In addition, the approval message may include use approved time of the CBRS channel to be used, and the base station may end providing a wireless communication service when the use approved time is exceeded, or interwork with the SAS server is not performed.

In addition, the approval message may include heartbeat time interval information, and the core delivers a heartbeat message at the heartbeat time interval to the SAS server. In addition, the core may be configured to receive a response message from the SAS server; and determine that the interwork with the SAS server is not performed when the response message is not received.

In addition, when the information on an available CBRS channel based on the position information of the base station is not received from the SAS server, or there is no CBRS channel available to be used, the core may request information on an available CBRS channel with respect to a plurality of positions; receive information on an available CBRS channel with respect to each of the plurality of positions from the SAS server; determine positions to provide a wireless communication service based on the information on an available CBRS channel with respect to each of the plurality of positions; and determine a CBRS channel to be used and a maximum transmission power based on the information on an available CBRS channel with respect to the positions.

In addition, the mobile base station may move to the determined position.

Another embodiment is a mobile base station configured to provide a wireless communication service using a citizen's broadband radio service (CBRS), including: a core (enhanced packet core or 5G core); and a base station, each of which being provided in one box, and the base station may be configured to be operated as a citizen's broadband radio service device (CBSD), the core may have a network address translation device configured to convert a private IP address of the base station into a public IP address, the base station may be configured to register in a spectrum access system (SAS) server based on predetermined CBSD information; obtain position information; request information on an available CBRS channel based on the position information to the SAS server; receive the information on an available CBRS channel based on the position information from the SAS server; determine a CBRS channel to be used and a maximum transmission power based on the information on an available CBRS channel; request an approval on the CBRS channel to be used and the maximum transmission power to the SAS server; receive an approval message from the SAS server; and provide a wireless communication service based on the determined CBRS channel to be used and the maximum transmission power.

In addition, the approval message may include use approved time of the CBRS channel to be used, and the base station may end providing a wireless communication service when the use approved time is exceeded, or interwork with the SAS server is not performed.

In addition, the approval message may include heartbeat time interval information, and the base station may deliver a heartbeat message at the heartbeat time interval to the SAS server; receive a response message from the SAS server; and determine that the interwork with the SAS server is not performed when the response message is not received.

In addition, when the information on an available CBRS channel based on the position information is not received from the SAS server, or there is no CBRS channel available to be used, the base station may request information on an available CBRS channel with respect to a plurality of positions; receive information on an available CBRS channel with respect to each of the plurality of positions from the SAS server; determine positions to provide a wireless communication service based on the information on an available CBRS channel with respect to each of the plurality of positions; and determine a CBRS channel to be used and a maximum transmission power based on the information on an available CBRS channel with respect to the positions.

Still another embodiment is a method for operating a mobile base station configured to provide a wireless communication service using a citizen's broadband radio service (CBRS), including: registering the base station in a spectrum access system (SAS) server; requesting information on an available CBRS channel based on the position information of the base station to the SAS server; receiving the information on an available CBRS from the SAS server; determining a CBRS channel to be used and a maximum transmission power based on the information on an available CBRS channel; requesting an approval on the CBRS channel to be used and the maximum transmission power to the SAS server; receiving an approval message from the SAS server; and providing a wireless communication service based on the determined CBRS channel to be used and the maximum transmission power.

In addition, the approval message may include use approved time of the CBRS channel to be used, and the method may further include ending providing a wireless communication service when the use approved time is exceeded, or interwork with the SAS server is not performed.

In addition, the approval message may include heartbeat time interval information, and the method may further include delivering a heartbeat message at the heartbeat time interval to the SAS server; and receiving a response message from the SAS server, and when the response message is not received, it may be determined that the interwork with the SAS server is not performed.

In addition, when the information on an available CBRS channel based on the position information of the base station is not received from the SAS server, or there is no CBRS channel available to be used, the method may further include requesting information on an available CBRS channel with respect to a plurality of positions; receiving information on an available CBRS channel with respect to each of the plurality of positions from the SAS server; determining positions to provide a wireless communication service based on the information on an available CBRS channel with respect to each of the plurality of positions; and determining a CBRS channel to be used and a maximum transmission power based on the information on an available CBRS channel with respect to the positions.

In addition, the method may further include: moving to the positions to provide the wireless communication service based on the determined positions.

The embodiments of the present disclosure allow the mobile base stations to provide the wireless communication service using the CBRS bandwidth, thereby providing a wireless communication service in regions where the wireless communication is made impossible.

### BRIEF DESCRIPTION OF THE DRAWINGS

FIG. 1 is a view illustrating a network configuration of a mobile base station using the CBRS bandwidth.

FIG. 2 is a view illustrating a network configuration of a mobile base station using the CBRS bandwidth according to a first embodiment of the present disclosure.

FIG. 3 is a flowchart illustrating a method for allowing a base station 200 of a mobile base station 20 to be allocated with the CBRS frequency and the output so as to provide a wireless communication service.

FIG. 4 is a view illustrating a network configuration of a mobile base station using the CBRS bandwidth according to a second embodiment of the present disclosure.

FIG. 5 is a flowchart illustrating a method for allowing a base station 200 of a mobile base station 20 to be allocated with the CBRS frequency and the output according to a second embodiment.

FIG. 6 is a flowchart illustrating an additional method for being allocated with the CBRS frequency and the output so as to provide a wireless communication service.

### DETAILED DESCRIPTION

Advantages and characteristics of the present disclosure and a method of achieving the advantages and characteristics will be clear by referring to example embodiments described below in detail together with the accompanying drawings. However, the present disclosure is not limited to example embodiment disclosed herein but will be implemented in various forms. The example embodiments are provided by way of example only so that a person of ordinary skilled in the art can fully understand the disclosures of the present disclosure and the scope of the present disclosure. Therefore, the present disclosure will be defined only by the scope of the appended claims. Like reference numerals generally denote like elements throughout the specification.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. The term “and/or” includes any and all combinations of one or more of the associated listed items.

The terms used in the present specification are merely used to describe specific embodiments and are not intended to limit the present invention. A singular expression includes a plural expression unless a description to the contrary is specifically pointed out in context. Components, steps, operations and/or elements that are referred to by terms “comprises” and/or “comprising” used in the inventive concept do not exclude presence or addition of one or more other components, steps, operations and/or elements.

Although the terms “first”, “second”, and the like are used for describing various components, these components are not confined by these terms. These terms are merely used for distinguishing one component from the other components.

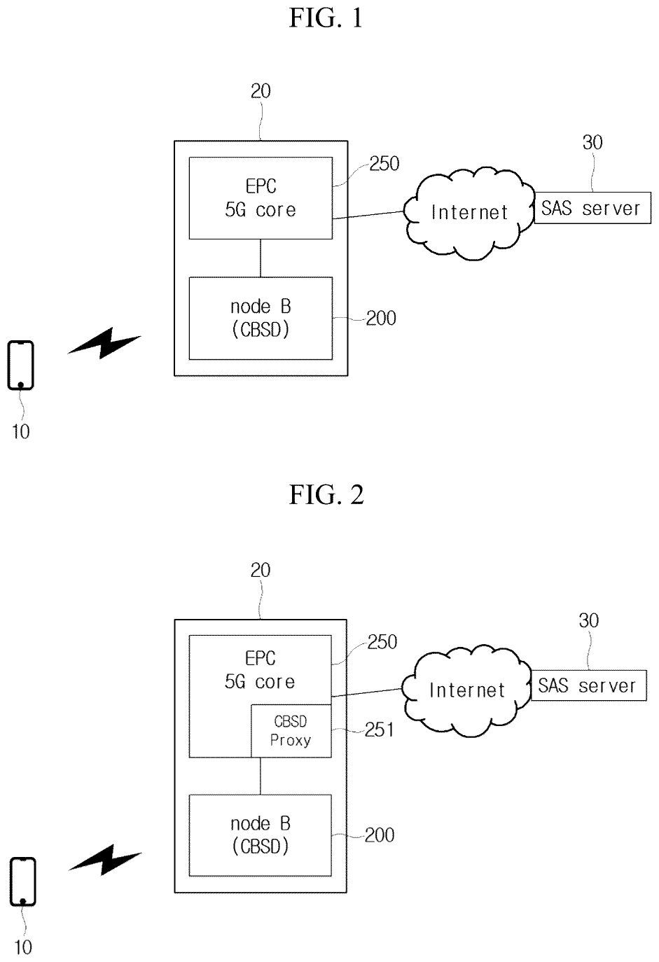

FIG. 1 is a view illustrating a network configuration of a mobile base station using the CBRS bandwidth.

A device configured to provide a communication service using frequency resources in the CBRS (citizen's broadband radio service) bandwidth may be referred to as the citizen's broadband radio service device (CBSD). A base station (node B) (200) of a mobile base station 20 illustrated in FIG. 1 may be a kind of the CBSD because it is a device which provides a telecom service using the frequency resource of the CBRS bandwidth.

As illustrated in FIG. 1, the base station 20 may have a core (enhanced packet core, EPC), or 5G core 250, and a base station 200 in one box, and an application service server (e.g.: PTT server) (not illustrated) additionally, and may provide the mobile communication service by easily configuring the exclusive LTE/5G network in a state of an emergency or a disaster.

The base station 200 of the mobile base station 20 is the CBSD, therefore, must be registered in the spectrum access system (SAS) and connected to the internet for interworking with the SAS all the time so as to provide the mobile communication service to terminals 10.

However, referring to the IP interwork structure illustrated in FIG. 1, the core 250 has a public data network (PDN) port and gets access to the internet network using a public IP, while the base station 200 is connected to the core 250 through a private IP via an internal interface, thereby the SAS interwork may not work because the base station 200 which is the CBSD cannot be connected directly to the SAS server 30. Accordingly, the base station 200 may not be allocated with and use the CBRS bandwidth frequency. Thus, in order for the base station 200 of the mobile base station 20 to be allocated with and to maintain the CBRS frequency, there is a need for measures to make interwork with the SAS server 30 possible.

FIG. 2 is a view illustrating a network configuration of the mobile base station using the CBRS bandwidth according to a first embodiment of the present disclosure.

Referring to the first embodiment illustrated in FIG. 2, the core 250 may have a CBSD proxy 251. The CBSD proxy 251 may serve as the CBSD on behalf of the base station 200.

The CBSD proxy 251 may register the base station 200 in the SAS on behalf of the base station 200. Therefore, the core 250, or the CBSD proxy 251 may have information necessary to register the base station 200 in the SAS.

In addition, the CBSD proxy 250 may interwork with the SAS on behalf of the base station 200, and be allocated with the CBRS frequency and the output.

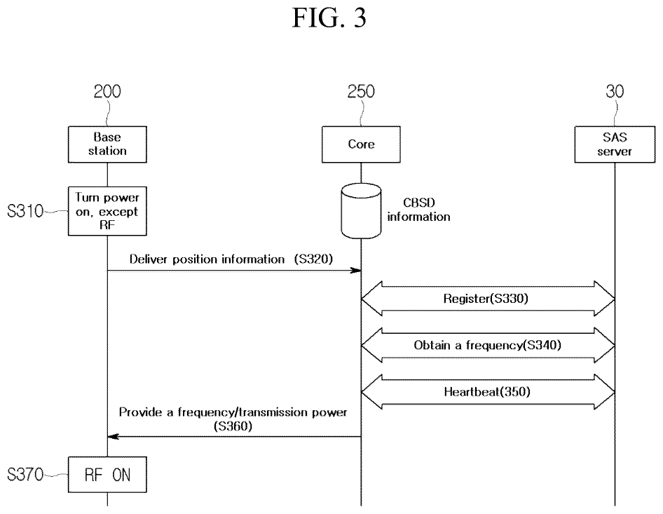

FIG. 3 is a flowchart illustrating a method for allowing the base station 200 of the mobile base station 20 to be allocated with the CBRS frequency and the output so as to provide a wireless communication service.

Referring to FIG. 3, the mobile base station 20 may move to a certain position to provide the wireless communication service. In addition, in an operation S310, the base station 200 of the mobile base station 20 may supply power to the remaining parts except the RF part configured to transmit or receive radio signals. The power may be supplied to the core 250 of the mobile base station 20.

In operation S320, the base station 200 may obtain information on the current position of the base station 200 and provide the information to the core 250.

In operation S330, the core 250 may register the base station 200 in the SAS server 30 on behalf of the base station 200, which is the CBSD. The core 250 may store, in advance, the CBSD information which includes various certificates of authentication and/or authentication keys necessary for authenticating the base station 200, and may request registration in the SAS server using the CBSD information and the position information that is to be delivered by the base station 200. Then, the SAS server 30 may register the base station 200 based on the CBSD information, and may inform completion of the registration to the core 250.

Upon completion of the registration, in operation S340, the core 250 may request information on an available CBRS channel to be used by the base station 200 so as to obtain the CBRS channel to be used for the wireless communication service. The SAS server 30 may evaluate usability of the CBRS channel in response to the request, and may provide the information on the available CBRS channel to the core 250. At this time, the SAS server 30 may provide the information on the available CBRS channel along with the rules and regulations to the core 250. The core 250 may transmit the information on the CBRS channel to be used and the maximum transmission power based on the received information on the available CBRS channel and the rules and regulations to the SAS server 30. The SAS server 30 determines whether the information on the CBRS channel to be used and the maximum transmission power conform to the rules and regulations, and if they conform to the rules and regulations, the SAS server 30 may provide a message approving use of the channel and the transmission power to the core 250. At this time, the SAS server 30 may provide the use approved time of the channel and information on a heartbeat time interval to the core 250.

In operation S350, the core 250 may provide a heartbeat message to the SAS server 30 at the heartbeat time interval received from the SAS server 30, and may inform that the base station 200 continues operating to the SAS server 30, by receiving a response message from the SAS server 30. In addition, the interwork with the SAS server 30 may be recognized.

In operation S360, the core 250 may provide the information on the CBRS channel to be used for the wireless communication service and the maximum transmission power to the bae station 200.

In operation S370, the base station 200 may turn on the RF, and provide the wireless communication service based on the information on the CBRS channel and the maximum transmission power received from the core 250.

Thereafter, the base station 200 may turn off the RF output when the above-mentioned approved time expires, or the interwork with the SAS server 30 is not performed (when the core 250 does not receive a response message from the SAS server 30 with respect to the heartbeat message transmitted to the SAS server 30).

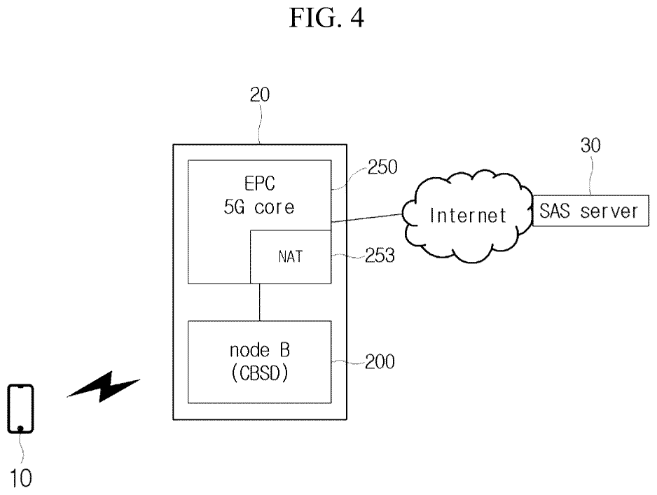

FIG. 4 is a view illustrating a network configuration of the mobile base station using the CBRS bandwidth according to a second embodiment of the present disclosure.

Referring to the second embodiment illustrated in FIG. 4, the core 250 may implement a network address translation (NAT) device 253. The NAT device 253 may be a device configured to provide conversion between a private IP address used by an internal private network, and a public IP address exposed outside. The core 250 may give a private IP address to equipment which use various IP addresses in the base station 200 and the core 250 inside the mobile base station 20, transmit data in the internal private network based on the private IP address, and transmit data to an external device using conversion of the private IP address and the public IP address by the NAT device 250.

The base station 200 which is the CBSD may be connected directly to the SAS server 30 through the NAT device 253 to play the role of the CBSD.

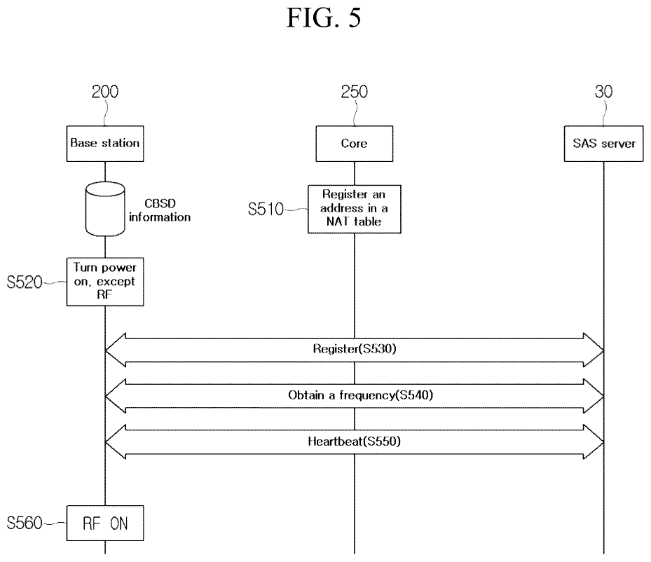

FIG. 5 is a flowchart illustrating a method for allowing the base station 200 of the mobile base station 20 to be allocated with the CBRS frequency and the output by according to the second embodiment.

Referring to FIG. 5, in operation S520, in a NAT table of the NAT device 253 provided in the core 250 of the mobile base station 20, a private IP address of the base station 200 may be registered. At this time, the private IP address of the base station 200 and a port number may be mapped to each other. Accordingly, a packet having a private IP address in the base station 200 and to be transmitted to an external device may be converted to have a port number mapped to a public IP address in the NAT device 253, and may be transmitted to an external device (e.g.; SAS server 30). In addition, a packet input from an external device may be converted into a packet having a private IP address mapped to a port number in the NAT device 253, and may be transmitted to the base station 200.

The mobile base station 20 may move to a certain position so as to provide the wireless communication service. Further, in operation S520, the base station 200 of the mobile base station 20 may supply power to the remaining parts except the RF part configured to transmit or receive radio signals. The power may be supplied to the core 250 of the mobile base station 20.

In operation S530, the base station 200 which is the CBSD may be registered in the SAS server 30. The base station 200 may store, in advance, the CBSD information including various certificates of authentication and/or the authentication keys necessary for authenticating the base station 200 as the CBSD, and may request registration to the SAS server 30 using the CBSD information and the position information of the base station 200 which is obtained by itself. Then, the SAS server 30 may register the base station 200 based on the CBSD information, and may inform completion of the registration to the base station 200. At this time, packets to be transmitted between the base station 200 and the SAS server 30 may be transmitted after performing the address conversion between the private IP address and the public IP address by the NAT device 253.

Upon completion of the registration, in operation S540, the base station 200 may request information on an available CBRS channel to be used by the base station 200 so as to obtain the CBRS channel to be used for the wireless communication service. The SAS server 30 may evaluate usability of the CBRS channel in response to the request, and may provide the information on the available CBRS channel to the base station 200. At this time, the SAS server 30 may provide the information on the available CBRS channel along with the rules and regulations to the base station 200. The base station 200 may transmit the information on the CBRS channel to be used and the maximum transmission power based on the received information on the available CBRS channel and the rules and regulations to the SAS server 30. The SAS server 30 determines whether the CBRS channel to be used and the information on the maximum transmission power conform to the rules and regulations, and if they conform to the rules and regulations, the SAS server 30 may provide a message approving use of the channel and the transmission power to the base station 200. At this time, the SAS server 30 may provide the use approved time of the channel and information on a heartbeat time interval to the base station 200.

In operation S550, the base station 200 may provide a heartbeat message to the SAS server 30 at the heartbeat time interval received from the SAS server 30, and may inform that the base station 200 continues operating to the SAS server 30, by receiving a response message from the SAS server 30. In addition, the base station 200 may recognize that the interwork with the SAS server 30 is ongoing, through the heartbeat message.

In operation S560, the base station 200 may turn on the RF, and provide the wireless communication service based on the information on the CBRS channel and the maximum transmission power received from the core 250.

Thereafter, the base station 200 may turn off the RF output when the above-mentioned approved time expires, or the interwork with the SAS server 30 is not performed (when the base station 200 does not receive a response message from the SAS server 30 with respect to the heartbeat message transmitted to the SAS server 30).

As described above, the base station 200 of the mobile base station 20 may be allocated with the CBRS channel from the SAS server 30 to provide the wireless communication service.

However, according to an embodiment, the mobile base station 20 ranked the lowest in a list of priority for the use of the CBRS channel, therefore, the mobile base station 20 may not be allocated with the CBRS channel, and the mobile base station 20 may not provide the wireless communication service if no CBRS channel is allocated thereto.

A movement capability of the mobile base station 20 may be used to address this problem.

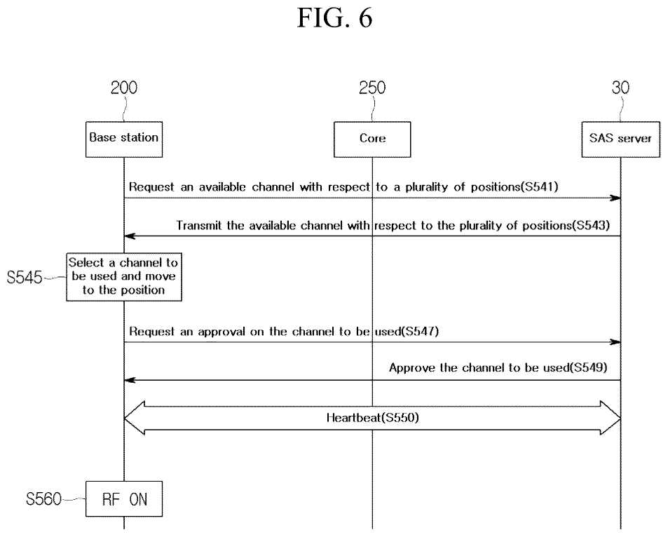

According to an embodiment, in operation S340 or S540, if no CBRS channel allowing the wireless communication service is allocated, the base station 200 or the core 250 may perform an additional measure for securing a channel as illustrated in FIG. 6.

FIG. 6 is a flowchart illustrating an additional method for being allocated with the CBRS frequency and the output so as to provide the wireless communication service.

The example of FIG. 6 is illustrated such that the core 250 has the NAT device 253 and the base station 200 performs the embodiment, however, it is well-known that the core 250 in FIG. 3 may perform the embodiment in the same way.

Referring to FIG. 6, in operation S541, the base station 200 may request the information on the CBRS channel with respect to a plurality of positions which are different from the current positions. In operation S543, the SAS server 30 may evaluate usability of the CBRS channel with respect to each of the positions in response to the request, and may provide the information on the CBRS channel available per position to the base station 200. At this time, the SAS server 30 may provide the information on the available CBRS channel along with the rules and regulations to the base station 200. In operation S545, the base station 200 may determine the positions to provide the wireless communication service, the CBRS channel to be used at the respective positions, and the maximum transmission power to be used based on the received information on the available CBRS channel per position and the rules and regulations. Then, the base station 200 may move to the determined position.

At this time, according to an embodiment, a method for selecting a position to provide the wireless communication service by the base station 200 may be to select the nearest position among a plurality of positions where available CBRS channels are disposed.

According to another embodiment, the base station 200 may select a position which may maximize the maximum available transmission power. In this case, it is effective in maximizing the coverage of the base station 200.

In operation S547, the base station 200 may transmit information on the CBRS channel to be used and the maximum transmission power to the SAS server 30.

In operation S549, the SAS server 30 determines whether the information on the CBRS channel to be used and the maximum transmission power conform to the rules and regulations, and if they conform to the rules and regulations, the SAS server 30 may provide a message approving use of the channel and the transmission power to the base station 200. At this time, the SAS server 30 may provide the use approved time of the channel and information on a heartbeat time interval to base station 200.

In operation S550, the base station 200 may provide a heartbeat message to the SAS server 30 at the heartbeat time interval received from the SAS server 30, and may inform that the base station 200 continues operating to the SAS server 30, by receiving a response message from the SAS server 30. In addition, the base station 200 may recognize that the interwork with the SAS server 30 is ongoing, through the heartbeat message.

In operation S560, the base station 200 may turn on the RF, and provide the wireless communication service based on the information on the CBRS channel and the maximum transmission power received from the core 250.

Thereafter, the base station 200 may turn off the RF output when the above-mentioned approved time expires, or the interwork with the SAS server 30 is not performed (when the base station 200 does not receive a response message from the SAS server 30 with respect to the heartbeat message transmitted to the SAS server 30).

As described above, if there is no available CBRS channel at a certain position, the mobile base station 20 may determine whether there is an available CBRS channel at another position, and if there is available CBRS channel at another position, the mobile base station 20 may move to another position so as to obtain the CBRS channel and to provide the wireless communication service.

Requesting an available channel with respect to a plurality of positions in the example of FIG. 6 may not conform to the CBRS standard and may request change in the SAS server 30, therefore, the base station 200 may use a method of including only one position in every channel request message, and transmitting a channel request message a plurality of times until there is an available CBRS channel to be used so that there is no influence to the operations of the SAS server 30.

The methods illustrated in FIG. 6 may provide a service after finding out an optimal position by comparing various positions to one another, while the above-described method allows to modify operations in the mobile base station 20 only, thereby making use of the movement capability of the mobile base station 20 sufficiently.

As described above, the present disclosure has suggested measures for obtaining CBRS channels so that the mobile base station 20 can provide a wireless communication service.

Accordingly, the present disclosure is effective in providing a wireless communication service in a region where the wireless communication service is unavailable, such as a region hit by a disaster etc., at a low cost.

What is claimed is:

1. A mobile base station configured to provide a wireless communication service using a citizen's broadband radio service (CBRS) frequency, comprising:
a core (enhanced packet core or 5G core) and a base station being provided in one box,
wherein the base station is configured to be operated as a citizen's broadband radio service device (CBSD),
wherein the core has CBSD information of the base station,
wherein the base station is configured to obtain position information and transmit the position information to the core,
wherein the core is configured to:
register the base station in a spectrum access system (SAS) server based on the CBSD information of the base station;
request information on an available CBRS channel based on the position information of the base station to the SAS server;
receive the information on an available CBRS channel based on the position information from the SAS server;
determine a CBRS channel to be used and a maximum transmission power based on the information on an available CBRS channel;
request an approval on the CBRS channel to be used and the maximum transmission power to the SAS server;
receive an approval message from the SAS server;
transmit the determined CBRS channel to be used and the maximum transmission power to the base station; and
provide a wireless communication service based on the determined CBRS channel to be used and the maximum transmission power.

2. The mobile base station of claim 1,
wherein the approval message comprises use approved time of the CBRS channel to be used, and
wherein the base station ends providing a wireless communication service when the use approved time is exceeded, or interwork with the SAS server is not performed.

3. The mobile base station of claim 2,
wherein the approval message comprises heartbeat time interval information, and
wherein the core delivers a heartbeat message at the heartbeat time interval to the SAS server;
receives a response message from the SAS server; and
determines that the interwork with the SAS server is not performed when the response message is not received.

4. The mobile base station of claim 1,
wherein when the information on an available CBRS channel based on the position information of the base station is not received from the SAS server, or there is no CBRS channel available to be used, the core requests information on an available CBRS channel with respect to a plurality of positions;
receives information on an available CBRS channel with respect to each of the plurality of positions from the SAS server;
determines positions to provide a wireless communication service based on the information on an available CBRS channel with respect to each of the plurality of positions; and
determines a CBRS channel to be used and a maximum transmission power based on the information on an available CBRS channel with respect to the positions.

5. The mobile base station of claim 4,
wherein the mobile base station moves to the determined position.

6. A mobile base station configured to provide a wireless communication service using a citizen's broadband radio service (CBRS), comprising:
a core (enhanced packet core or 5G core); and
a base station, each of which being provided in one box,
wherein the base station is configured to be operated as a citizen's broadband radio service device (CBSD),
wherein the core has a network address translation device configured to convert a private IP address of the base station into a public IP address,
wherein the base station is configured to:
register in a spectrum access system (SAS) server based on predetermined CBSD information;
obtain position information;
request information on an available CBRS channel based on the position information to the SAS server;
receive the information on an available CBRS channel based on the position information from the SAS server;
determine a CBRS channel to be used and a maximum transmission power based on the information on an available CBRS channel;
request an approval on the CBRS channel to be used and the maximum transmission power to the SAS server;
receive an approval message from the SAS server; and
provide a wireless communication service based on the determined CBRS channel to be used and the maximum transmission power.

7. The mobile base station of claim 6,
wherein the approval message comprises use approved time of the CBRS channel to be used, and
wherein the base station ends providing a wireless communication service when the use approved time is exceeded, or interwork with the SAS server is not performed.

8. The mobile base station of claim 7,
wherein the approval message comprises heartbeat time interval information, and
wherein the base station delivers a heartbeat message at the heartbeat time interval to the SAS server;
receives a response message from the SAS server; and
determines that the interwork with the SAS server is not performed when the response message is not received.

9. The mobile base station of claim 6,
wherein when the information on an available CBRS channel based on the position information is not received from the SAS server, or there is no CBRS channel available to be used, the base station requests information on an available CBRS channel with respect to a plurality of positions;
receives information on an available CBRS channel with respect to each of the plurality of positions from the SAS server;
determines positions to provide a wireless communication service based on the information on an available CBRS channel with respect to each of the plurality of positions; and
determines a CBRS channel to be used and a maximum transmission power based on the information on an available CBRS channel with respect to the positions.

10. The mobile base station of claim 9,
wherein the mobile base station moves to the determined position.

11. A method for operating a mobile base station configured to provide a wireless communication service using a citizen's broadband radio service (CBRS), comprising:
registering the base station in a spectrum access system (SAS) server;
requesting information on an available CBRS channel based on the position information of the base station to the SAS server;
receiving the information on an available CBRS from the SAS server;
determining a CBRS channel to be used and a maximum transmission power based on the information on an available CBRS channel;
requesting an approval on the CBRS channel to be used and the maximum transmission power to the SAS server;
receiving an approval message from the SAS server; and
providing a wireless communication service based on the determined CBRS channel to be used and the maximum transmission power.

12. The method of claim 11,
wherein the approval message comprises use approved time of the CBRS channel to be used, and
wherein the method of claim 11 further comprises ending providing a wireless communication service when the use approved time is exceeded, or interwork with the SAS server is not performed.

13. The method of claim 12,
wherein the approval message comprises heartbeat time interval information, and wherein the method of claim 12 further comprises:
delivering a heartbeat message at the heartbeat time interval to the SAS server; and
receiving a response message from the SAS server, and
wherein when the response message is not received, it is determined that the interwork with the SAS server is not performed.

14. The method of claim 11,
wherein when the information on an available CBRS channel based on the position information of the base station is not received from the SAS server, or there is no CBRS channel available to be used, the method further comprises:
requesting information on an available CBRS channel with respect to a plurality of positions;
receiving information on an available CBRS channel with respect to each of the plurality of positions from the SAS server;
determining positions to provide a wireless communication service based on the information on an available CBRS channel with respect to each of the plurality of positions; and
determining a CBRS channel to be used and a maximum transmission power based on the information on an available CBRS channel with respect to the positions.

15. The method of claim 14, further comprising:
moving to the positions to provide the wireless communication service based on the determined positions.
